(19) United States
(12) Patent Application Publication
(10) Pub. No.: US 2015/0074630 A1
(43) Pub. Date: Mar. 12, 2015

(54) LAYOUT METHOD OF SEMICONDUCTOR INTEGRATED CIRCUIT AND RECORDING MEDIUM

(71) Applicant: KABUSHIKI KAISHA TOSHIBA, Tokyo (JP)

(72) Inventor: Toshihiro AKIYAMA, Kanagawa (JP)

(73) Assignee: KABUSHIKI KAISHA TOSHIBA, Tokyo (JP)

(21) Appl. No.: 14/199,726

(22) Filed: Mar. 6, 2014

(30) Foreign Application Priority Data
Sep. 9, 2013 (JP) 2013-186537

(51) Int. Cl. G06F 17/50

(52) U.S. Cl. CPC G06F 17/5081
USPC 716/114

(57) ABSTRACT

A layout method of a semiconductor integrated circuit includes detecting a path having a constraint violation in a laid-out semiconductor integrated circuit, determining an insertable range of a buffer to be inserted on a route of the path so as to remove the constraint violation, evaluating, with respect to a cell already placed in the insertable range, a wiring length, and presence or absence of a constraint violation if the cell is hypothetically moved to an empty space in a vicinity of the insertable range, determining an insertion position of the buffer based on a result of the evaluation, moving the cell already placed at the insertion position of the buffer to the empty space in the vicinity of the insertable range, placing the buffer at the insertion position, and rerouting the buffer and the moved cell.

### CROSS-REFERENCE TO RELATED APPLICATION

This application is based upon and claims the benefit of priority from the prior Japanese Patent Application No.2013-186537 filed on Sep. 9, 2013; the entire contents of which are incorporated herein by reference.

### FIELD

Embodiments described herein relate generally to a layout method of a semiconductor integrated circuit and a recording medium.

### BACKGROUND

In general, in a layout design of a semiconductor integrated circuit, after all cells have been placed and detailed routing has been completed, timing for sign off and the like are analyzed. In this analysis, it is checked whether or not the circuit satisfies various constraining conditions such as setup time, hold time, maximum capacitance and maximum slew time. Conventionally, if these constraining conditions are not satisfied and there is a violation location, optimization of the circuit has been performed by inserting a buffer at the violation location. Specifically, first, a region where a constraint violation can be removed by inserting a buffer (hereinafter referred to as a preferred buffer placing region) is obtained and a buffer is inserted at a location where no cell is placed in the preferred buffer placing region (hereinafter referred to as a space).

In order to remove the constraint violation by inserting a buffer, it is important to maintain the cell positions and wiring already set as much as possible. This is because if the already set cells and wiring are much changed, there is a case where the timing, the capacitance and the slew time are significantly collapsed and there is a possibility that the design does not come to converge (or enormous time is required to come to converge). However, in a case where there is no space having a size sufficient for placing a buffer in the preferred buffer placing region, a buffer has to be placed in a space outside the preferred buffer placing region and the constraint violation can not be removed only by placing a buffer. In such a case, it is necessary to add a new buffer and optimize wiring many times and there has been a problem that it takes a huge time for the design to converge. Further, in this conventional method, a number of redundant buffers are placed to cause a problem that a chip size is enlarged or power consumption is increased.

### BRIEF DESCRIPTION OF THE DRAWINGS

FIG. 1 is a schematic block diagram illustrating a structure of a layout designing apparatus using a layout method of a semiconductor integrated circuit according to an embodiment of the present invention;

FIG. 2 is a schematic circuit layout diagram for illustrating an example of a preferred buffer placing region 41; and

FIG. 3 is a diagram for illustrating an example of an evaluation table 31.

### DETAILED DESCRIPTION

A layout method of a semiconductor integrated circuit according to the present embodiment includes detecting a path having a constraint violation in a laid-out semiconductor integrated circuit, determining an insertable range of a buffer to be inserted on a route of the path so as to remove the constraint violation, evaluating, with respect to a cell already placed in the insertable range, a wiring length and presence or absence of a constraint violation if the cell is hypothetically moved to an empty space in a vicinity of the insertable range, determining an insertion position of the buffer based on a result of the evaluation, moving the cell already placed at the insertion position of the buffer to the empty space in the vicinity of the insertable range, placing the buffer at the insertion position, and rerouting the buffer and the moved cell.

Hereinafter, an embodiment will be explained referring to the drawings.

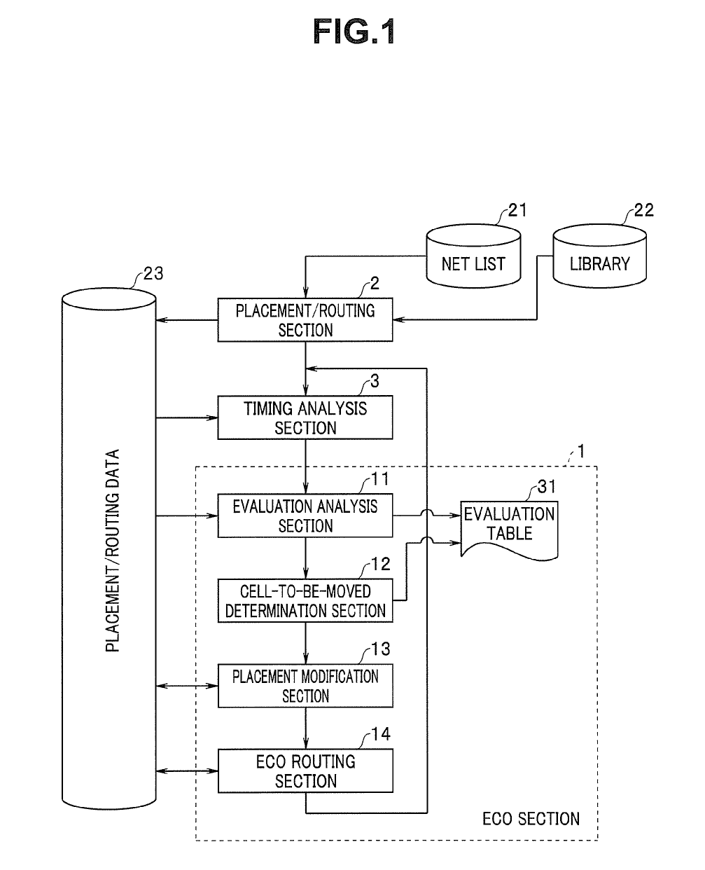

FIG. 1 is a schematic block diagram illustrating a structure of a layout designing apparatus using a layout method of a semiconductor integrated circuit according to an embodiment of the present invention. As shown in FIG. 1, the layout designing apparatus of this embodiment includes a placement/routing section 2 that performs a layout design such as placement of cells and routing, a timing analysis section 3 that detects presence/absence of a constraint violation such as timing, and an ECO (Engineering Change Order) section 1 that redoes the layout design for removing the constraint violation while maintaining the existing layout design information as much as possible.

Into the placement/routing section 2, a net list 21 which is a design data describing a list of nets that connect between elements, and a library 22 that is a group of parts of a circuit are inputted. A circuit layout designed by the placement/routing section 2 is outputted to a placement/routing data 23 and stored therein.

The timing analysis section 3 reads out the circuit layout designed by the placement/routing section 2 from the placement/routing data 23, and various analyses such as timing analysis are performed therein. Specifically, wiring capacitance extraction, delay calculation, static timing analysis (STA), etc. are performed and timing information (setup time, hold time), wiring capacitance, slew time, etc. are calculated. The calculated values are compared with constraining conditions which the circuit has to satisfy and presence/absence of a constraint violation is checked.

In the ECO section 1, if it is determined that a constraint violation is caused in the designed circuit layout by the timing analysis section 3, redesigning of the layout is performed. As means for removing a timing violation, a wiring capacitance violation, a slew time violation, in general, means for inserting a buffer at a circuit location where the violation is caused is used. Therefore, in the ECO section 1 according to the present embodiment also, removal of the constraint violation is carried out by insertion of a buffer.

The ECO section 1 is configured to include an evaluation analysis section 11, a cell-to-be-moved determining section 12, a placement modification section 13, and an ECO routing section 14. The evaluation analysis section 11 determines an insertion range (a preferred buffer placing region) capable of removing the constraint violation and evaluates influence if a cell already placed in the range is moved to a region in the vicinity of the preferred buffer placing region. Note that an evaluation result is outputted as an evaluation table 31. The cell-to-be-moved determining section 12 determines a position at which a buffer is to be inserted and a location to which the cell already placed at the position is moved based on the evaluation result in the evaluation analysis section 11. The placement modification section 13 places the already placed cell and a buffer to be inserted, according to the determination in the cell-to-be-moved determining section 12. The ECO routing section 14 performs routing at locations where routing is necessary due to the movement of the already placed cell and the newly placed buffer.

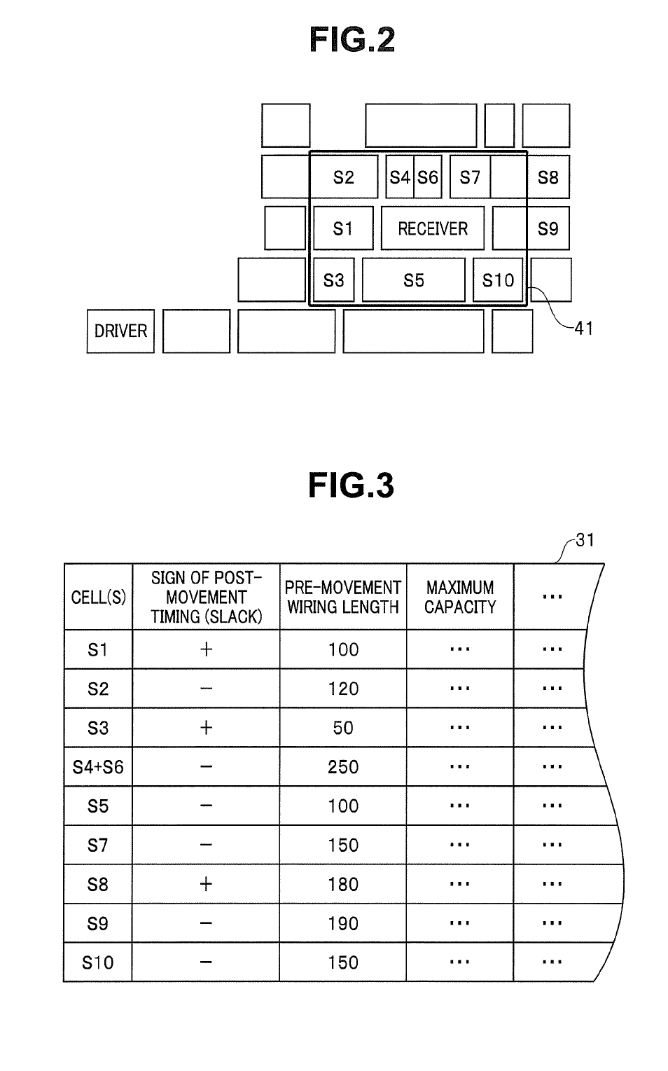

Next, a layout procedure of a semiconductor integrated circuit according to the present embodiment will be explained using FIG. 1, FIG. 2 and FIG. 3. FIG. 2 is a schematic circuit layout diagram for illustrating an example of a preferred buffer placing region 41. FIG. 3 is a diagram for illustrating an example of the evaluation table 31.

First, in the placement/routing section 2, a circuit layout is designed by placing cells and wiring using data of the net list 21 and the library 22. The designed circuit layout is outputted to the placement/routing data 23 and stored therein. Then, in the timing analysis section 3, various analyses such as timing are performed with respect to the circuit layout designed by the placement/routing section 2. As a result of the analyses, if it is determined that there is no constraint violation, the circuit layout design is terminated.

On the other hand, if it is determined that there is a constraint violation, redesigning of the layout is performed with respect to a location of the constraint violation in the ECO section 1. For example, a case will be explained where the cell placement as shown in FIG. 2 has been carried out in the placement/routing section 2 and there is a timing constraint violation in a path connecting a driver and a receiver.

First, in the evaluation analysis section 11, the already designed circuit layout is read from the placement/routing data 23. Then, the path connecting the driver and the receiver which is a location of the constraint violation is extracted. Subsequently, a placing range of a buffer (a preferred buffer placing region) which is capable of removing the constraint violation by placing a buffer in the range is determined. Specifically, on the condition that all the already placed cells except the driver and the receiver are ignored and a buffer can be placed at an arbitrary position other than the driver and the receiver, the preferred buffer placing region is determined by performing the What-IF analysis in which setup time, hold time, wiring capacitance, slew time, etc. are calculated while varying a hypothetical placing position of a buffer. For example, in one example shown in FIG. 2, the preferred buffer placing region 41 is determined to be a range including ten cells (cells S1-S10) which are placed on the periphery of the receiver.

In this manner, not by searching a space which physically allows placement of a buffer taking account of the already placed cells, but by searching an optimum placing range for removing the constraint violation on the condition that the already placed cells are included in a region where placement is possible, the preferred buffer placing region can be determined at high speed and the constraint violation can be securely removed.

Next, evaluation is made with respect to influence if the cell already placed in the preferred buffer placing region 41 is moved to an empty space outside the preferred buffer placing region 41 (a region where no cell is placed). For example, in one example of FIG. 2, each of the already placed ten cells S1-S10 is hypothetically moved to the closest empty space outside the preferred buffer placing region 41, and evaluation is made regarding various items such as timing to create the evaluation table 31 as shown in FIG. 3.

As the evaluation items, in addition to presence or absence of a violation after moving the cell, a length of wiring connected to the cell before moving the cell (pre-movement wiring length) is calculated and evaluated with respect to the analysis items performed in the timing analysis section 3 (timing information (setup time, hold time), wiring capacitance, slew time, etc.). Note that, in the evaluation table 31 shown in FIG. 3, the setup time violation and the hold time violation after movement of the cell are evaluated, with calculation of timing slack, by signs of the slack. The evaluation items are not limited to the items shown in the evaluation table 31, and an item or items other than the shown items may be appropriately added as necessary. Further, with respect to the timing slack, not only the signs but also numerical values thereof may be used.

Besides, with respect to the already placed cells S1-S10 in the preferred buffer placing region 41, two or more cells, not only one, may be moved. For example, in a case where a size of a buffer to be inserted is larger than that of the cell S4, the cell S4 and the cell S6 adjacent to the cell S4 may be moved to an empty space in the vicinity of the preferred buffer placing region 41 and the buffer may be placed in a region that has become empty. Therefore, in a case where there is possibility of moving a plurality of cells at a time such as the case where the buffer to be inserted is larger than the already placed cell, it is necessary to perform evaluation in the case where the plurality of cells are moved at a time and perform listing in the evaluation table 31. (For example, a fourth row of CELL(S) “S4+S6” indicates evaluation in the case where two cells are moved at a time.)

Furthermore, a plurality of already placed cells may be moved successively. For example, it may be performed such that the cell S1 is moved to an empty space in the vicinity of the preferred buffer placing region 41, the cell S10 is moved to a position of the cell S1, and a buffer is inserted into a position of the cell S10. In this case also, it is necessary to perform evaluation in the case where the two cells S10 and 51 are moved successively and perform listing in the evaluation table 31.

When the preparation of the evaluation table 31 is completed in the evaluation analysis section 11, a potion at which a buffer is to be inserted and a location to which the cell already placed in the position is to be moved are determined. When moving the cell placed in the preferred buffer placing region 41 to a region in the vicinity thereof, it is required not to cause a constraint violation at the location where the cell is moved. Therefore, in the evaluation table 31, candidates for cells to be moved are determined as cells indicating that the sign of post-movement timing slack is zero or positive. However, if there is not any cell indicating that the sign of timing slack is zero or positive, a cell having of a value of the timing slack closest to zero (i.e. largest) is set to be a candidate for the cell to be moved. For example, in the case of the evaluation table 31 shown in FIG. 3, three cells of the cell S1, the cell S3 and the cell S8 become candidates for movement. Next, from among these candidates for movement, a cell having the shortest pre-movement wiring length is selected as the cell to be moved. For example, in the case of the evaluation table 31 shown in FIG. 3, among the three cells S1, S3 and S8, the cell S3 is a cell having the shortest pre-movement wiring length. Thus, the cell S3 is determined as the cell to be moved, and it is finally determined that a buffer is to be placed in a region where the cell S3 is placed. Besides, if there are two or more cells having the shortest pre-movement wiring length, the cell to be moved is determined taking the other evaluation items comprehensively into consideration.

Next, in the placement modification section 13, the already placed cell in the preferred buffer placing region 41 which is determined as the cell to be moved (e.g. the cell S3 in the above example) is moved to an empty space in the vicinity of the preferred buffer placing region 41 and a buffer is placed in an empty space formed after the movement. Information about the moved cell and the newly placed buffer is outputted to the placement/routing data 23 and stored therein. Subsequently, in the ECO routing section 14, routing is performed at locations where connection is required by the movement of the already placed cell and by the newly placed buffer. The wiring information is outputted to the placement/routing data 23 and stored therein.

With respect to the circuit layout after the movement of the already placed cell, the insertion of the buffer and the rerouting, various analyses such as timing analysis are performed in the timing analysis section 3. When it is determined that the constraint violation is removed and that there is no constraint violation in the other paths, the circuit layout design is terminated. When it is determined that a constraint violation exists in the other paths, the above procedure in the ECO section 1 is executed with respect to the path including the violation.

Thus, according to the present embodiment, in removing the violation by inserting a buffer at a location of the constraint violation in the circuit layout, a region in which cells are already placed is set as a region in which a buffer can be placed and the optimum placing region for removing the violation is searched, and thereby the preferred buffer placing region can be determined at high speed and time required for the layout design to converge can be shortened and also the constraint violation can be securely removed.

Further, according to the present embodiment, when selecting a cell to be moved to an empty space in the vicinity of the preferred buffer placing region from among the cells already placed in the region so as to secure a placing region of a buffer, a cell without causing a constraint violation and with the short pre-movement wiring length is selected and moved by evaluating the timing analysis and the pre-movement wiring length, etc. if an already placed cell is moved, and therefore it is possible to prevent occurrence of a new constraint violation by the movement of the already placed cell and further shorten the time for the layout design to converge.

Furthermore, it is possible to prevent insertion of a redundant buffer or addition of wiring for removing the constraint violation.

The respective “sections” in the present specification are conceptions corresponding to the respective functions in the embodiments and do not necessarily have one-to-one correspondence to the specific hardware or software routine. Therefore, in the specification, the embodiments have been explained assuming virtual circuit blocks (sections) having the respective functions in the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A layout method of a semiconductor integrated circuit, comprising:
detecting a path having a constraint violation in a laid-out semiconductor integrated circuit;
determining an insertable range of a buffer to be inserted on a route of the path so as to remove the constraint violation;
evaluating, with respect to a cell already placed in the insertable range, a wiring length, and presence or absence of a constraint violation if the cell is hypothetically moved to an empty space in a vicinity of the insertable range;
determining an insertion position of the buffer based on a result of the evaluation;
moving the cell already placed at the insertion position of the buffer to the empty space in the vicinity of the insertable range;
placing the buffer at the insertion position; and
rerouting the buffer and the moved cell.

2. The layout method of the semiconductor integrated circuit, according to claim 1, wherein
the insertion position of the buffer is determined as a position of a cell having a largest value of timing slack if the cell is hypothetically moved to the empty space in the vicinity of the insertable range.

3. The layout method of the semiconductor integrated circuit, according to claim 1, wherein
with respect to cells already placed in the insertable range, evaluation of presence or absence of a constraint violation is made if each of the cells already placed in the insertable range is hypothetically moved to an empty space in the vicinity of the insertable range with a shortest distance of movement.

4. The layout method of the semiconductor integrated circuit, according to claim 2, wherein
with respect to cells already placed in the insertable range, evaluation of presence or absence of a constraint violation is made if each of the cells already placed in the insertable range is hypothetically moved to an empty space in the vicinity of the insertable range with a shortest distance of movement.

5. The layout method of the semiconductor integrated circuit, according to claim 1, wherein
a plurality of cells which are already placed in the insertable range are combined into a cell group, and evaluation of a total wiring length and presence or absence of a constraint violation is made if the cell group or each of cells already placed in the insertable range is moved to an empty space in the vicinity of the insertable range with a shortest distance of movement.

6. The layout method of the semiconductor integrated circuit, according to claim 2, wherein
a plurality of cells which are already placed in the insertable range are combined into a cell group, and evaluation of a total wiring length and presence or absence of a constraint violation is made if the cell group or each of cells already placed in the insertable range is hypothetically moved to an empty space in the vicinity of the insertable range with a shortest distance of movement.

7. The layout method of the semiconductor integrated circuit, according to claim 3, wherein
a plurality of cells which are already placed in the insertable range are combined into a cell group, and evaluation of a total wiring length and presence or absence of a constraint violation is made if the cell group or each of cells already placed in the insertable range is hypothetically moved to an empty space in the vicinity of the insertable range with the shortest distance of movement.

8. The layout method of the semiconductor integrated circuit, according to claim 4, wherein
a plurality of cells which are already placed in the insertable range are combined into a cell group, and evaluation of a total wiring length and presence or absence of a constraint violation is made if the cell group or each of cells already placed in the insertable range is hypothetically moved to an empty space in the vicinity of the insertable range with the shortest distance of movement.

9. A computer readable recording medium recording a layout program for a semiconductor integrated circuit for causing a computer to execute a layout of the semiconductor integrated circuit, the recording medium causing the computer to execute processing comprising:
detecting a path having a constraint violation in a laid-out semiconductor integrated circuit;
determining an insertable range of a buffer to be inserted on a route of the path so as to remove the constraint violation;
evaluating, with respect to a cell already placed in the insertable range, a wiring length, and presence or absence of a constraint violation if the cell is hypothetically moved to an empty space in a vicinity of the insertable range;
determining an insertion position of the buffer based on a result of the evaluation;
moving the cell already placed at the insertion position of the buffer to the empty space in the vicinity of the insertable range;
placing the buffer at the insertion position; and
rerouting the buffer and the moved cell.

10. The recording medium according to claim 9, wherein the recording medium causes the computer to execute processing of:
determining the insertion position of the buffer as a position of a cell having a largest value of timing slack if the cell is hypothetically moved to the empty space in the vicinity of the insertable range.

11. The recording medium according to claim 9, wherein the recording medium causes the computer to execute processing of:
evaluating, with respect to cells already placed in the insertable range, presence or absence of a constraint violation if each of the cells already placed in the insertable range is hypothetically moved to an empty space in the vicinity of the insertable range with a shortest distance of movement.

12. The recording medium according to claim 10, wherein the recording medium causes the computer to execute processing of:
evaluating, with respect to cells already placed in the insertable range, presence or absence of a constraint violation if each of the cells already placed in the insertable range is hypothetically moved to an empty space in the vicinity of the insertable range with a shortest distance of movement.

13. The recording medium according to claim 9, wherein the recording medium causes the computer to execute processing of:
combining a plurality of cells which are already placed in the insertable range into a cell group, and evaluating a total wiring length and presence or absence of a constraint violation if the cell group or each of cells already placed in the insertable range is moved to an empty space in the vicinity of the insertable range with a shortest distance of movement.

14. The recording medium according to claim 10, wherein the recording medium causes the computer to execute processing of:
combining a plurality of cells which are already placed in the insertable range into a cell group, and evaluating a total wiring length and presence or absence of a constraint violation if the cell group or each of cells already placed in the insertable range is moved to an empty space in the vicinity of the insertable range with the shortest distance of movement.

15. The recording medium according to claim 11, wherein the recording medium causes the computer to execute processing of:
combining a plurality of cells which are already placed in the insertable range into a cell group, and evaluating a total wiring length and presence or absence of a constraint violation if the cell group or each of cells already placed in the insertable range is moved to an empty space in the vicinity of the insertable range with a shortest distance of movement.

16. The recording medium according to claim 12, wherein the recording medium causes the computer to execute processing of:
combining a plurality of cells which are already placed in the insertable range into a cell group, and evaluating a total wiring length and presence or absence of a constraint violation if the cell group or each of cells already placed in the insertable range is moved to an empty space in the vicinity of the insertable range with a shortest distance of movement.
